(19) United States
(12) Patent Application Publication
(10) Pub. No.: US 2020/0241557 A1
(43) Pub. Date: Jul. 30, 2020

(54) INFORMATION PROCESSING APPARATUS AND METHOD OF INFORMATION PROCESSING

(71) Applicant: TOYOTA JIDOSHA KABUSHIKI KAISHA, Toyota-shi (JP)

(72) Inventors: Hideo HASEGAWA, Nagoya-shi (JP); Tadahiro KASHIWAI, Nagoya-shi (JP); Yusuke KANEKO, Toyota-shi (JP); Akihiro YAMAGUCHI, Toyota-shi (JP); Yuki ITO, Iwakura-shi (JP); Naoki UENOYAMA, Nisshin-shi (JP); Takahiro SHIGA, Chiryu-shi (JP)

(73) Assignee: TOYOTA JIDOSHA KABUSHIKI KAISHA, Toyota-shi (JP)

(21) Appl. No.: 16/732,389

(22) Filed: Jan. 2, 2020

(30) Foreign Application Priority Data
Jan. 24, 2019 (JP) 2019-010388

(51) Int. Cl. G05D 1/02; G08G 1/00; G06Q 30/02; G06Q 30/06

(52) U.S. Cl. CPC G05D 1/0278; G06Q 30/0641; G06Q 30/0212; G08G 1/207

(57) ABSTRACT

An information processing apparatus for controlling a mobile object configured to provide a commodity or service while touring a plurality of areas, the apparatus including a control unit configured to execute: predicting a business result of the mobile object that tours the areas, and generating business prediction data; and generating a coupon to be provided to users who are present in any one of the areas and distributing coupon data including the coupon to terminals associated with the users such that the business result satisfies a prescribed policy.

### INCORPORATION BY REFERENCE

The disclosure of Japanese Patent Application No. 2019-010388 filed on Jan. 24, 2019 including the specification, drawings and abstract is incorporated herein by reference in its entirety.

### BACKGROUND

### 1. Technical Field

The present disclosure relates to a mobile shop using a vehicle.

### 2. Description of Related Art

Research has been conducted for providing services using mobile objects. For example, sending an autonomous mobile object (mobile shop vehicle) that functions as a mobile shop to users can enhance the convenience for shopping.

There is known a method used in the case of performing business at a plurality of spots with use of a mobile shop vehicle. In the method, the business spots are determined based on a predicted demand. There is also known a method of generating a route connecting the thus-determined business spots, and allowing the mobile object (mobile shop vehicle) to autonomously move.

### SUMMARY

However, even when the business spots and the route are determined by the aforementioned method, it does not necessarily optimize a sales result.

The present disclosure has been made in consideration of the above-described problem, and it is an object of the present disclosure to optimize a business result in a mobile object system that performs business with a mobile object that tours a plurality of spots.

An information processing apparatus according to the present disclosure is an information processing apparatus for controlling a mobile object configured to provide a commodity or service while touring a plurality of areas, the apparatus includes a control unit. The control unit is configured to execute: predicting a business result of the mobile object that tours the areas, and generating business prediction data; and generating a coupon to be provided to users who are present in any one of the areas and distributing coupon data including the coupon to terminals associated with the users such that the business result satisfies a prescribed policy.

A method of information processing according to the present disclosure is a method of information processing performed by an information processing apparatus for controlling a mobile object configured to provide a commodity or service while touring a plurality of areas. The method includes the steps of: predicting a business result of the mobile object that tours the areas and generating business prediction data; and generating a coupon to be provided to users who are present in any one of the areas and distributing coupon data including the coupon to terminals associated with the users such that the business result satisfies a prescribed policy.

Another aspect of the present disclosure is a program for causing a computer to execute a method of information processing executed by the information processing apparatus, or a non-transitory computer readable storage medium that stores the program.

The present disclosure can optimize a business result in a mobile object system that provides a commodity or service with a mobile object that tours a plurality of areas.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of a mobile object system in a first embodiment;

FIG. 2 is a block diagram schematically showing examples of component members included in the system;

FIG. 3 is a flowchart showing a data flow between the component members of the system;

FIG. 4 is an example of a road network in the first embodiment;

FIG. 5 is an explanatory view of demand data in the first embodiment;

FIG. 6 is an explanatory view of business prediction data in the first embodiment;

FIG. 7 is an explanatory view of coupon data in the first embodiment;

FIG. 8 is a flowchart of a process executed by a server apparatus in a second embodiment; and

FIG. 9 is a flowchart of a process executed by a server apparatus in a third embodiment.

### DETAILED DESCRIPTION OF EMBODIMENTS

There may be a form of supplying a commodity or service in a shop that is configured with a multiple-purpose mobile object capable of traveling autonomously. For example, a mobile shop vehicle having in the vehicle a facility or equipment for performing business as a shop can be sent to a prescribed area, where the facility or equipment may be developed to perform the business.

The area or spot where the mobile shop vehicle performs business can be determined based on a users' demand. However, in the form of the mobile shop vehicle that performs business while touring a plurality of spots, some problems may arise. One of the problems is that the demand is not necessarily proportional to sales (profits). In short, the route that can satisfy the users' demand to the maximum does not necessarily equal to the route that maximizes the sales or profits.

Another one of the problems is difficulty in correcting a tour route. For example, even when sales fall below an estimated amount after the tour is started, it is difficult to change a transit spot to an area expected to be more profitable. In the case of notifying a tour schedule to the consumers in advance in particular, it is difficult to change the tour route.

As a solution, an information processing apparatus according to an embodiment predicts a business result of the mobile object that tours the areas, and generates business prediction data. The information processing apparatus also generates a coupon to be provided to users who are present in any one of the areas, and distributes coupon data including the coupon to the terminals associated with the users such that the business result satisfies a prescribed policy.

The information processing apparatus according to the present embodiment first predicts a business result based on demand data or the like. Then, the information processing apparatus determines the content of a coupon provided to users present within the areas covered by the tour such that the business result satisfies a prescribed policy. Examples of the prescribed policy include “selling out all the stocks”, “minimizing out-of-stock conditions”, “maximizing business profits”, and “maximizing sales”. However, the prescribed policy is not limited to these. The prescribed policy may be a combination of a plurality of policies. According to the configuration, even after the tour route is determined, the coupon is dynamically generated, which makes it possible to control the volume of sales or the profits. The term “business” used in this specification is a concept including selling a commodity and providing a service.

The control unit may be configured to determine a discount rate of the coupon for each of the areas based on the prescribed policy. With the configuration, it becomes possible to control the volume of sales or the profits per area.

The control unit may be configured to: acquire demand data that is information regarding a demand in the areas; and generate a route for touring the areas based on the demand data.

The control unit may also be configured to: re-predict the business result based on second demand data acquired after transmitting the coupon data; and generate and distribute a second coupon higher in discount rate than the coupon such that the business result satisfies the prescribed policy.

The users' demand for a commodity or service is not unchanged. The demand changes depending on the day of the week or the time of the day. To cope with the change, when the demand changes after the coupon data is transmitted, a coupon of a higher discount rate may be generated and distributed. This makes it possible to promote use of the service.

The second demand data may be data including a response situation from the terminals that are transmission destinations of the coupon. For example, when a user saves a coupon, a response (feedback) may automatically be transmitted. Thus, the response may be used as one piece of the demand data.

The control unit may also be configured to: acquire business achievement data from the mobile object on tour; re-predict the business result in consideration of the business achievement data; and generate and distribute a third coupon higher in discount rate than the coupon such that the business result satisfies the prescribed policy.

Using the business achievement data enhances the accuracy of prediction. As a consequence, a coupon having a more appropriate content may additionally be generated.

The control unit may also be configured to add to the coupon data information regarding the time when the mobile object reaches the corresponding area. With the configuration, the convenience of the users can be enhanced.

### First Embodiment

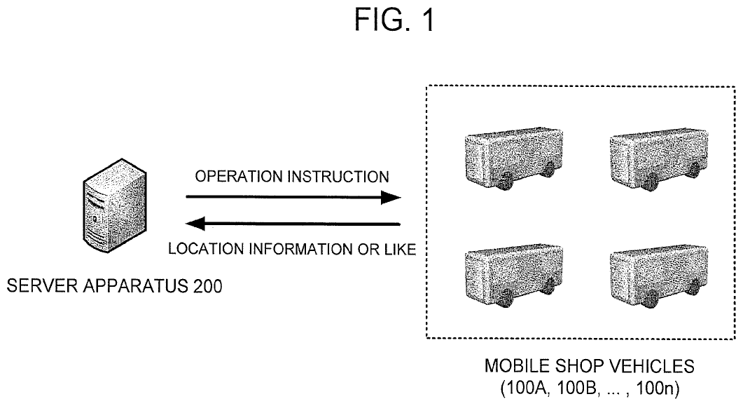

The outline of a mobile shop system according to a first embodiment will be described with reference to FIG. 1. The mobile shop system according to the present embodiment is configured by including a plurality of mobile shop vehicles 100A to 100n that perform autonomous travel based on a given instruction, and a server apparatus 200 that issues the instruction. The mobile shop vehicles 100 are autonomous driving vehicles that provide prescribed services. The server apparatus 200 manages the mobile shop vehicles 100. Hereinafter, the mobile shop vehicles are simply referred to as mobile shop vehicles 100 when the vehicles are collectively referred without being identified respectively.

The mobile shop vehicles 100 are multiple-purpose mobile objects that may have functions different from each other. The mobile shop vehicles 100 can perform autonomous driving and unmanned driving on the roads. The mobile shop vehicles 100 are designed to move shops, facilities, and equipment. After traveling to destinations, the mobile shop vehicles 100 can develop the facilities or the like to perform business. The mobile shop vehicles 100 are also called electric vehicle (EV) pallets. The mobile shop vehicles 100 are not necessarily unmanned vehicles. For example, a staff such as an operating staff, a reception staff, and a security guard, may be aboard. The mobile shop vehicles 100 may not necessarily be vehicles that can perform a completely autonomous travel. For example, the mobile shop vehicles 100 may be vehicles that are driven by a person or that assist driving in accordance with situations. The mobile shop vehicles 100 may further have functions to accept a request from a user, respond to the user, execute a specified process in response to the request from the user, and report the result of executing the process. For example, the mobile shop vehicles 100 may execute a process of performing settlement of a commodity or service, a process of dispensing a commodity, or the like, during business. Among the requests from the users, those unprocessable by the mobile shop vehicles 100 by themselves may be transferred to the server apparatus 200, and be processed in cooperation between the mobile shop vehicles 100 and the server apparatus 200.

The server apparatus 200 instructs the mobile shop vehicles 100 to operate. In the present embodiment, the server apparatus 200 determines the spots where a prescribed mobile shop vehicle 100 performs business. The server apparatus 200 then transmits to the prescribed mobile shop vehicle 100 an operation instruction instructing “develop a shop and perform business at a plurality of business spots, while touring the business spots. Thus, the server apparatus 200 can make the mobile shop vehicle 100 perform business as a shop at a plurality of spots. The operation instructions may include instructions other than the instructions regarding travel of the vehicle, development of the shop, and withdrawal of the shop. For example, the operation instructions may include an instruction stating “make an announcement to neighboring users in the vicinity of the business spots”. Thus, the operation instructions may include the operations to be performed by the mobile shop vehicles 100 in addition to the travel instruction.

In the present embodiment, the server apparatus 200 acquires information (demand data) regarding a demand for a commodity or service provided by a target mobile shop vehicle 100, and determines a plurality of spots where the mobile shop vehicle 100 performs business based on the demand. The demand data indicates a rough number of users having the needs for the commodity or service in each of the areas. For example, the demand data may be expressed by the identifier of each commodity or service, the area, and the number of users, or the like. The demand data is generated based on the result of analyzing big data, a past volume of sales of the mobile shop vehicle, information (such as questionnaires, and SNS data) transmitted from users, or the like. The generated demand data is supplied to the server apparatus 200 from the outside of the system through a network, for example. The spots where the mobile shop vehicle 100 performs business may be generated based on the result of predicting the business result of the mobile shop vehicle 100 with use of the demand data.

The server apparatus 200 also generates a coupon that is provided to users who are present in any one of the areas in a tour route, and distributes the generated coupon to the terminals (hereinafter user terminals) associated with the users such that the result of the business by the mobile shop vehicle 100 can satisfy a prescribed policy. This makes it possible to control the sales or profits in each of the areas. Generation and distribution of the coupon will be described later in detail.

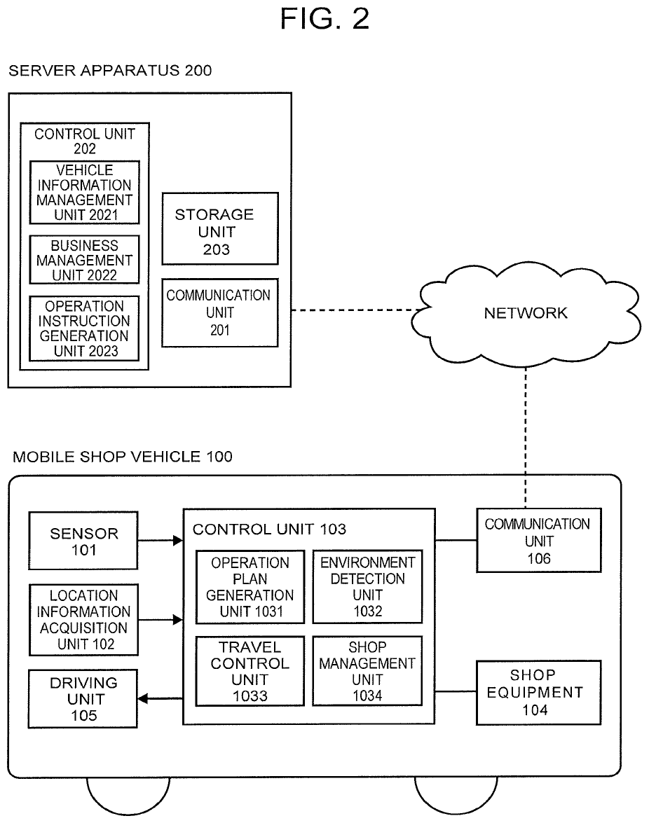

Now, component members of the system will be described in detail. FIG. 2 is a block diagram schematically showing one example of the configuration of the mobile shop vehicle 100 and the server apparatus 200 shown in FIG. 1. Two or more mobile shop vehicles 100 may be provided.

The mobile shop vehicle 100 is a vehicle that travels based on an operation instruction acquired from the server apparatus 200. Specifically, the mobile shop vehicle 100 travels based on the operation instruction acquired through a wireless communication, and develops a shop at a plurality of spots set on the route to perform business.

The mobile shop vehicle 100 is configured by including a sensor 101, a location information acquisition unit 102, a control unit 103, shop equipment 104, a driving unit 105, and a communication unit 106. The mobile shop vehicle 100 operates with electric power supplied from an unillustrated battery.

The sensor 101 is means for sensing the periphery of the vehicle. The sensor 101 is typically configured by including a laser scanner, a LIDAR, and a radar. The information acquired by the sensor 101 is transmitted to the control unit 103. The sensor 101 may also include a camera provided in a vehicle body of the mobile shop vehicle 100. For example, an image sensor, such as a charge-coupled device (CCD), a metal-oxide-semiconductor (MOS), or a complementary metal-oxide-semiconductor (CMOS), may be used.

The location information acquisition unit 102 is means for acquiring the current location of a vehicle. The location information acquisition unit 102 is typically configured by including a GPS receiver. The information acquired by the location information acquisition unit 102 is transmitted to the control unit 103.

The control unit 103 is a computer that controls the mobile shop vehicle 100 based on the information acquired from the sensor 101. The control unit 103 is constituted of a microcomputer, for example.

The control unit 103 includes an operation plan generation unit 1031, an environment detection unit 1032, a travel control unit 1033, and a shop management unit 1034 as functional modules. The functional modules may each be implemented by executing programs stored in storage means, such as a read only memory (ROM) (not illustrated), on a central processing unit (CPU) (not illustrated).

The operation plan generation unit 1031 acquires an operation instruction from the server apparatus 200, and generates an operation plan of the own vehicle. In the present embodiment, the operation plan is data that defines a travel route of the mobile shop vehicle 100 and also defines processes to be performed by the mobile shop vehicle 100 in some or all parts of the route. Examples of the data included in the operation plan may include the following data.

(1) Data Indicating Route of Own Vehicle as Group of Road Links

For example, the travel route of the own vehicle may automatically be generated with reference to map data stored in unillustrated storage means and based on the information, such as a place of departure, a destination, business spots, and an order of touring the business spots, given from the server apparatus 200. The travel route of the own vehicle may also be generated by using an external service.

(2) Data Indicating Processes to be Performed by Own Vehicle at Spots on Route

The processes to be performed by the own vehicle include, for example, “develop or collect the shop” and “perform publicity activities.” However, the processes are not limited to these. The operation plan generated by the operation plan generation unit 1031 is transmitted to the travel control unit 1033 described later.

The environment detection unit 1032 detects the environment around the vehicle based on the data acquired by the sensor 101. Examples of detection targets include the number and location of lanes, the number and location of the vehicles present around the own vehicle, the number and location of obstacles (for example, pedestrians, bicycles, structures, buildings, and the like) present around the own vehicle, the structure of roads, and road signs. However, the detection targets are not limited to these. The detection targets may be any objects as long as the objects are necessary for autonomous travel. The environment detection unit 1032 may track a detected object. For example, a relative speed of an object may be obtained from a difference between coordinates of the object detected one step before and current coordinates of the object. The data about environment (hereinafter, environment data) detected by the environment detection unit 1032 is transmitted to the travel control unit 1033 described later.

The travel control unit 1033 controls a travel of the own vehicle based on the operation plan generated by the operation plan generation unit 1031, the environment data generated by the environment detection unit 1032, and the location information on the own vehicle acquired by the location information acquisition unit 102. For example, the travel control unit 1033 makes the own vehicle travel along a prescribed route while preventing obstacles from entering into a prescribed safety area around the own vehicle. As a method of implementing an autonomous travel of the vehicle, a publicly-known method may be adopted.

The shop management unit 1034 controls the later-described shop equipment 104 so as to operate the mobile shop vehicle 100 as a mobile shop.

The shop equipment 104 is a plurality of equipment for the mobile shop vehicle 100 to function as a shop. Examples of the shop equipment 104 may include equipment for advertising a commodity or service, equipment for exhibiting a commodity or service, equipment for performing settlement of a price or fee, and equipment for interacting with users. However, the shop equipment 104 may be other than these equipment. In the case of an unmanned shop, the shop equipment 104 may include means for identifying the commodity that a user wishes to purchase, and for providing settlement in a self-service mode.

The driving unit 105 is means for making the mobile shop vehicle 100 travel based on an instruction generated by the travel control unit 1033. The driving unit 105 is configured by including, for example, a motor, an inverter, a brake, a steering mechanism, and a secondary battery for driving wheels. The communication unit 106 is communication means for connecting the mobile shop vehicle 100 to a network. In the present embodiment, the communication unit 106 can communicate with other apparatuses (for example, server apparatus 200) via a network with use of a mobile communication service, such as 3G and LTE. The communication unit 106 may further have communication means for performing vehicle-to-vehicle communication with other mobile shop vehicles 100.

Description is now given of the server apparatus 200. The server apparatus 200 manages the mobile shop vehicles 100, and generates and transmits an operation instruction to the mobile shop vehicles 100. For example, when receiving an operation request of any one of the mobile shop vehicles 100 from a system administrator, the server apparatus 200 selects an appropriate mobile shop vehicle 100, and transmits an operation instruction to the vehicle.

The server apparatus 200 is configured by including a communication unit 201, a control unit 202, and a storage unit 203. The communication unit 201 is a communication interface, similar to the communication unit 106, for communication with the mobile shop vehicles 100 via a network.

The control unit 202 is means for controlling the server apparatus 200. The control unit 202 is constituted of a CPU, for example. The control unit 202 has a vehicle information management unit 2021, a business management unit 2022, and an operation instruction generation unit 2023 as functional modules. The functional modules may each be implemented by executing programs stored in storage means, such as a ROM (not illustrated), on the CPU (not illustrated).

The vehicle information management unit 2021 manages the mobile shop vehicles 100 under management. Specifically, the vehicle information management unit 2021 receives from the mobile shop vehicles 100 location information, route information, event information, or the like, for every prescribed cycle, and stores the information in association with a date and time in storage unit 203 described later. The location information indicates the current location of each of the mobile shop vehicles 100. The route information relates to the routes on which the mobile shop vehicles 100 are scheduled to travel. The event information relates to events (for example, development and withdrawal of shops) occurring in the mobile shop vehicles 100 in operation.

The vehicle information management unit 2021 retains and updates data (hereinafter, vehicle information) regarding the characteristics of the mobile shop vehicles 100 as necessary. Example of the vehicle information includes an identifier, a usage and type, a door type, a vehicle body size, a load capacity, a passenger capacity, a travelable distance at a full charge state, a current travelable distance, and a current status (waiting, vacant, in service, traveling, in business, or the like) of each of the mobile shop vehicles 100. However, the vehicle information may be other than these pieces of information. The vehicle information management unit 2021 may further retain the information regarding, for example, a stock amount of each commodity provided by the mobile shop vehicles 100, a commodity supply capacity, and a service provision capacity.

The business management unit 2022 manages the operation of the mobile shop vehicles 100 as mobile shops. Specifically, the business management unit 2022 performs the following processes:

### (1) Determination of Spots (Business Spots) to Perform Business

The business management unit 2022 acquires demand data from an external apparatus, and determines desirable spots for a target mobile shop vehicle 100 to perform business based on the acquired demand data. For example, out of a plurality of areas that the mobile shop vehicle 100 can access, the business management unit 2022 extracts two or more areas where the demand for a commodity or service is equal to or greater than a prescribed value, and determines a business spot for each of the extracted areas.

### (2) Prediction of Business Result

The business management unit 2022 predicts the result of business performed by the target mobile shop vehicle 100. For example, based on the demand data described before, or business achievement data (described later) transmitted from the mobile shop vehicle 100, the business management unit 2022 predicts the result of business in one operation (tour). The result of business may be any information, as long it relates to the business performed by the mobile shop vehicle. For example, the result of business may be a sales amount, or may be a profit amount. The result of business may also be an unsold stock of a commodity, or the like.

### (3) Generation and Distribution of Coupon

When determining that the predicted business result does not satisfy a prescribed policy, the business management unit 2022 generates a coupon (coupon data) provided to the users who are present in any one of the target areas, and distributes the coupon data to the user terminals associated with the users. This makes it possible to control the sales or profits at a specific business spot. A discount rate of the coupon may dynamically be changed for each of the areas in accordance with a degree of attainment of the aforementioned policy.

The operation instruction generation unit 2023 generates an operation instruction to be transmitted to the mobile shop vehicle 100 based on the determined business spots.

The storage unit 203, which is means for storing information, is constituted of a storage medium, such as a RAM, a magnetic disk, and a flash memory.

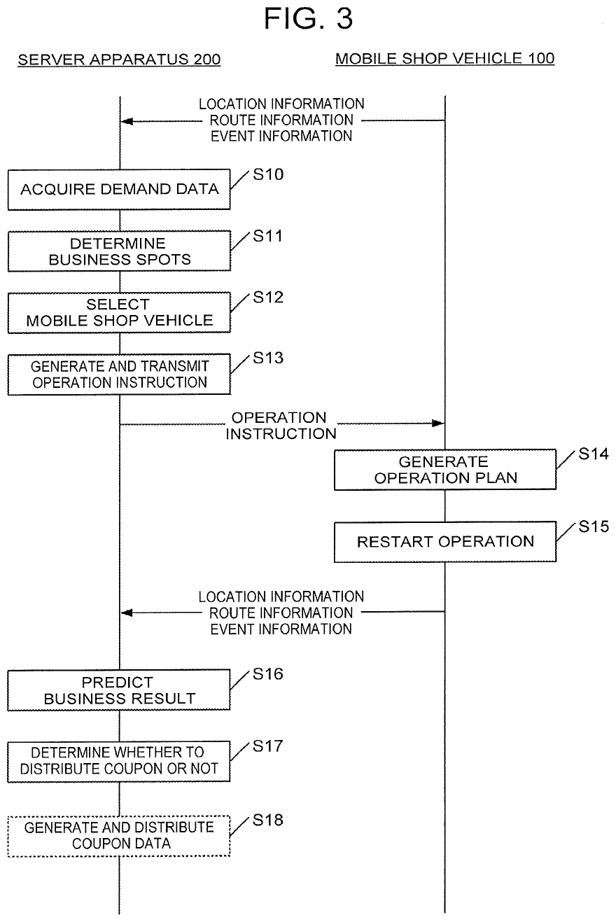

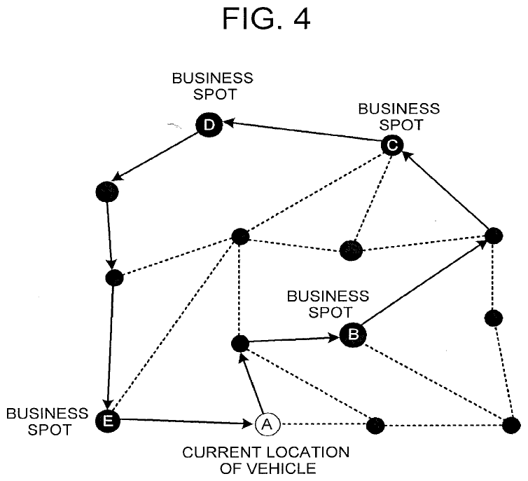

The processes performed by the component members described before will be described. FIG. 3 is a flowchart illustrating a process in which the server apparatus 200 generates an operation instruction based on the request of a system administrator, and a target mobile shop vehicle 100 starts operation. In this example, the mobile shop vehicle 100 operates along a road network shown in FIG. 4.

The mobile shop vehicle 100 periodically transmits location information to the server apparatus 200. In the example of FIG. 4, the mobile shop vehicle 100 notifies the server apparatus 200 that the mobile shop vehicle 100 is located in a node A. The vehicle information management unit 2021 stores in the storage unit 203 the mobile shop vehicle 100 in association with the node A. The location information may not necessarily be the location information on the node itself. For example, the location information may be information for identifying a node or a link. Moreover, one link may be divided into a plurality of sections. The road network may not necessarily be constituted of nodes and links. Whenever the mobile shop vehicle 100 moves, the location information is updated.

The mobile shop vehicle 100 may periodically transmit route information to the server apparatus 200. For example, when the mobile shop vehicle 100 is in operation, the mobile shop vehicle 100 may transmit information indicating its operation route to the server apparatus 200 as the route information. The mobile shop vehicle 100 may also transmit event information to the server apparatus 200. The event information is description of events that may be generated during operation, such as development and withdrawal of the shop. The event information may be transmitted at the timing when a corresponding event is generated.

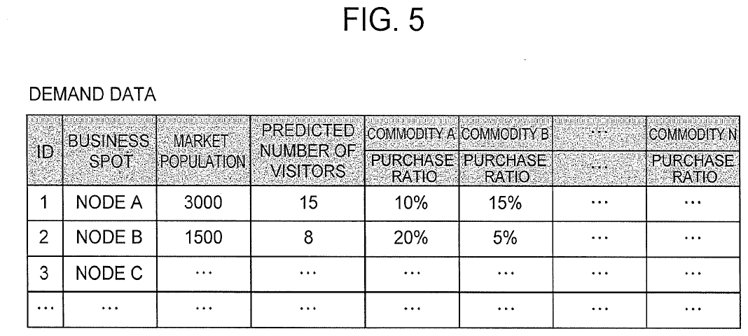

When the administrator transmits a vehicle allocation request to the server apparatus 200 through unillustrated communication means, the process shown in FIG. 3 is started. First, the business management unit 2022 acquires the demand data in step S10. The demand data includes, for example, a market population, the number of persons (predicted number of visitors) expected to visit the mobile shop vehicle 100 as a mobile shop, and a ratio of the persons expected to purchase any commodity or service in each of the areas corresponding to the business spots. FIG. 5 shows an example of the demand data.

The demand data may also be generated by an external apparatus based on, for example, accumulated big data. In the present embodiment, the demand data is constantly updated by the external apparatus, and the business management unit 2022 can acquire the latest demand data via the network. The demand data may be defined for every date, day of the week, and time slot. In that case, the business management unit 2022 may acquire the demand data conforming to the operation date, the operation time slot, and the like, of the mobile shop vehicle 100.

Next, in step S11, the business management unit 2022 determines spots (business spots) that the mobile shop vehicle 100 performs business based on the acquired demand data. In this example, the business management unit 2022 determines that the mobile shop vehicle 100 performs business at nodes B, C, D, E shown in FIG. 4.

In step S12, the operation instruction generation unit 2023 selects a mobile shop vehicle 100 that provides a service. For example, the operation instruction generation unit 2023 determines the mobile shop vehicle 100 that can provide the requested service and that can go to the business spots determined in step S11, with reference to the stored location information and vehicle information on the mobile shop vehicles 100. Here, the vehicle located in the node A shown in FIG. 4 is selected. Based on the selection, the server apparatus 200 transmits an operation instruction to the target mobile shop vehicle 100 (step S13).

In step S14, the mobile shop vehicle 100 (operation plan generation unit 1031) generates an operation plan based on the received operation instruction. In this example, the mobile shop vehicle 100 generates the operation plan for traveling along the route shown with a solid line in FIG. 4, opening a mobile shop in the nodes B, C, D, E to perform business, and returning to the node A. The generated operation plan is transmitted to the travel control unit 1033, and operation is started (step S15). Transmission of the location information, and the like, to the server apparatus 200 is periodically performed while the mobile shop vehicle 100 is in operation.

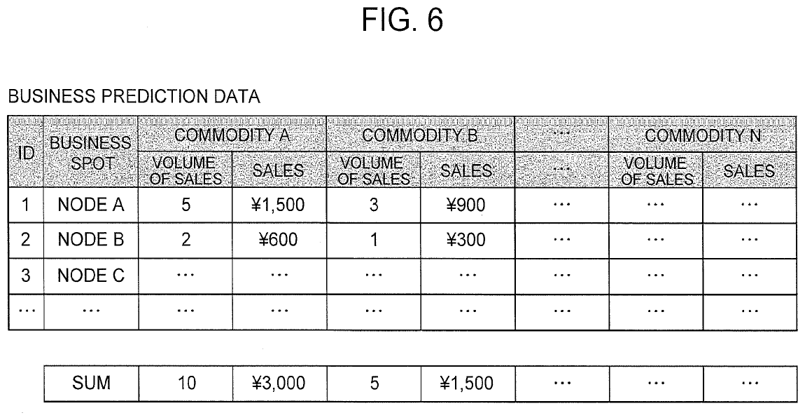

When the server apparatus 200 transmits an operation instruction, the business management unit 2022 predicts the result of business performed by the mobile shop vehicle 100 in step S16. FIG. 6 is an example of data (business prediction data) on the predicted result of business. The business prediction data includes, for example, the sales number of every commodity, and the sales or profit of every commodity. The business prediction data can be generated based on, for example, information regarding the selected mobile shop vehicle 100 (for example, a stock amount of a commodity, a commodity supply capacity, a service provision capacity, and the like), the route information (for example, business spots) generated by the mobile shop vehicle 100, the demand data used in step S11, the latest demand data, and the like. As described above, the system administrator can properly set, the sales, the profit amount, or the sales number of a commodity or service, as an object to be predicted as a result of the influence.

In step S17, the business management unit 2022 compares the business prediction data with the policy set by the system administrator, and determines whether to distribute a coupon or not. The coupon is a discount ticket or a service ticket distributed to the users who are present in a specific area where the mobile shop vehicle 100 performs business. In the present embodiment, the coupon is generated as electronic data and transmitted to the user terminals possessed by the target users.

In the present embodiment, the coupon is distributed when the result of the business predicted in step S16 does not satisfy the preset policy. The policy set by the administrator includes the followings. However, the policy is not limited to these. (1) The stock of the commodity in the end of business is less than a prescribed number. (2) The sales amount in one business (tour) exceeds a prescribed amount. (3) The profit amount in one business (tour) exceeds a prescribed amount.

When the result of business predicted in step S16 does not satisfy the preset policy, the business management unit 2022 determines to distribute the coupon in step S17. When the result of business predicted in step S16 satisfies the preset policy, the process described below is not performed.

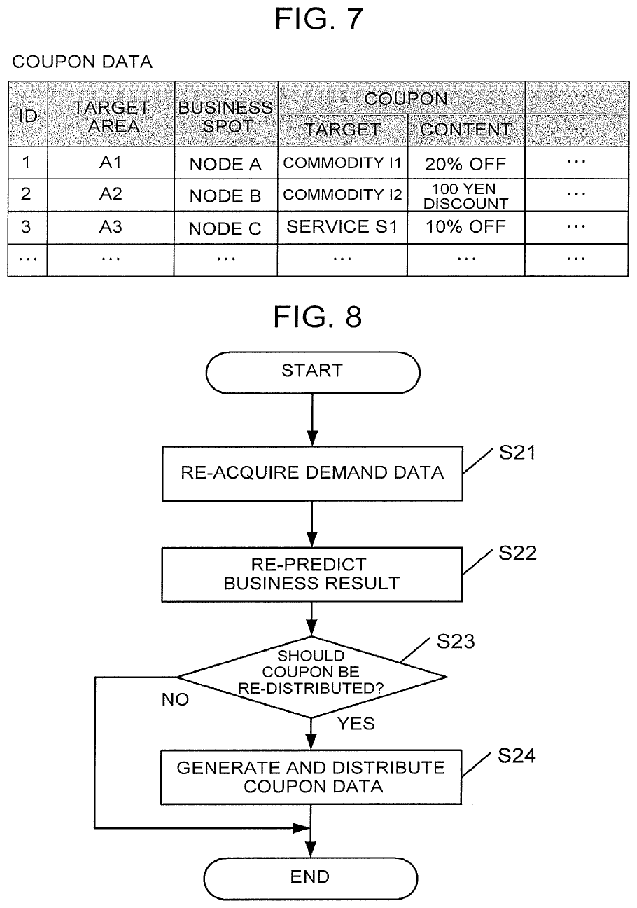

In step S18, the business management unit 2022 determines a coupon distribution target area and a content of the coupon, generates coupon data, and transmits the generated coupon data to the user terminals associated with the target users. FIG. 7 is an example of the coupon data to be generated. The coupon data includes information for identifying a coupon distribution target area, a business spot included in the area, information for identifying a commodity or service covered by the coupon, and the content of the coupon. In addition, coupon encoded data, bar code data, electronic banking data, or the like, may be attached to the coupon data.

The area where the coupon is distributed can be determined by any methods. For example, where there is an area lower in predicted number of visitors, number of sales, profit amount, or the like as compared with other areas, the area is preferentially selected as the coupon distribution area. For example, when the sales in the node C is lower than the sales in other areas, the business management unit 2022 determines to distribute the coupon to the users in the area corresponding to the node C. The content (discount rate or the like) of the coupon can be determined based on past business achievement data that reflects the coupon distribution. When the coupon is distributed to a plurality of areas, the content (discount rate or the like) of the coupon may be changed for each of the areas. The content of the coupon may also be changed in accordance with an attribute of the users. Furthermore, the attribute of the users who receive the distributed coupon may be limited depending on the commodity or service.

The user terminals as coupon data transmission destinations can be determined based on the information registered in advance. For example, the server apparatus 200 stores residence areas and e-mail addresses of the users in advance, and may transmit the coupon data to the e-mail addresses of the matching users. The server apparatus 200 may periodically collect location information from the user terminals, and transmit the coupon data to the user terminals that are present in a target area in the form of push notification. A known method may be adopted as a method of transmitting the coupon data to the user terminals. The coupon data may include data regarding a tour schedule of the mobile shop vehicle 100 (data regarding the spots or time slot where and when the shop is developed), and data (advertisement or the like) regarding a commodity or service treated by the mobile shop vehicle 100.

As described in the foregoing, in the mobile shop system according to the first embodiment, the result of business by the mobile shop vehicle is predicted, and a coupon is dynamically distributed, based on the result of the prediction, to the users in the area covered by the mobile shop vehicle. According to the configuration, in the form of the mobile shop vehicle that tours a plurality of business spots, it becomes possible to control the volume of sales or profits, without changing the tour route of the mobile shop vehicle.

### Second Embodiment

According to the first embodiment, the server apparatus 200 acquires the demand data, and acquires the business spots before the mobile shop vehicle 100 starts operation, and distributes a coupon. However, the demand for a commodity or service may continuously change. For example, when the time slot or the weather changes, the demand for a commodity or service may change. To cope with the change in demand, a second embodiment is configured such that after the mobile shop vehicle 100 starts operation, the server apparatus 200 re-acquires the demand data, and re-distributes the coupon based on the re-acquired demand data. Re-distributing the coupon can adapt the form of supplying a commodity or service to the changed demand.

FIG. 8 is a flowchart of a process executed by the server apparatus 200 in the second embodiment. After the coupon distribution in the first embodiment is performed, the business management unit 2022 starts the process shown in FIG. 8 at given timing.

First, the business management unit 2022 acquires latest demand data (second demand data) in step S21. When a user reacts to the coupon distributed in step S18, the business management unit 2022 may determine occurrence of a demand. For example, in the system where a coupon becomes available when the coupon is acquired (download), the action of acquiring the coupon signifies that the user may have an intention of visiting the shop. Accordingly, the number of times that the action of “acquiring the coupon” is taken may be counted, and the occurrence of the demand may be determined depending on the number of times. Such an action can also be treated as indicating a user's demand for the commodity or service.

In step S22, based on the second demand data acquired in step S21, the business management unit 2022 re-predicts the business result, and generates business prediction data (second business prediction data). Then in step S23, the business management unit 2022 determines whether to further distribute a coupon based on the second business prediction data.

Specifically, the business management unit 2022 compares the result of prediction performed in step S16 with the result of prediction performed in step S22. When determining that the business result fails to satisfy the prescribed policy even with the distribution of the coupon, the business management unit 2022 determines to re-distribute a coupon. In step S24, the business management unit 2022 generates and distributes the coupon data. The coupon generated in step S24 may have a content more advantageous for the users than that of the coupon generated in step S18. For example, the coupon may present a higher discount rate for a specific commodity or service. This is an effective policy, when the demand declines after the mobile shop vehicle starts the tour. As described in the foregoing, according to the second embodiment, the content of the coupon can appropriately be corrected based on the demand data acquired in real time.

### Third Embodiment

In a third embodiment, the server apparatus 200 acquires business achievement data from a target mobile shop vehicle 100, and regenerates the business prediction data in consideration of the business achievement data.

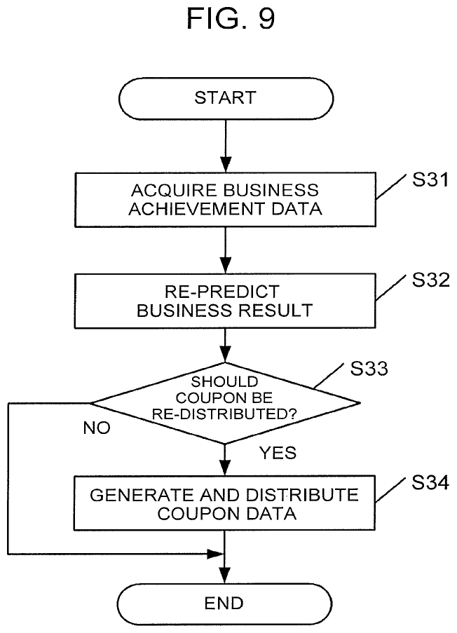

FIG. 9 is a flowchart of a process executed by the server apparatus 200 in the third embodiment. After the coupon distribution in the first embodiment is performed, the business management unit 2022 starts the process shown in FIG. 9 at given timing.

First, in step S31, the business management unit 2022 acquires latest business achievement data at present time from the mobile shop vehicle 100. The business achievement data includes, for example, the sales number of commodities, and the sales and profit of each of the commodities up to the present time. The business achievement data is generated based on the information transmitted from the target mobile shop vehicle 100. The mobile shop vehicle 100 transmits the business achievement data to the server apparatus 200 at the timing when the business at a specific business spot is ended, or in real time. It is preferable that the business achievement data has the same items as the business prediction data.

In step S32, based on the business achievement data acquired in step S31, the business management unit 2022 re-predicts the business result, and generates business prediction data (third business prediction data). Then in step S33, the business management unit 2022 determines whether to further distribute a coupon based on the third business prediction data.

Specifically, the business management unit 2022 compares the result of prediction performed in step S16 with the result of prediction performed in step S32. When determining that the business result fails to satisfy the prescribed policy even with the distribution of the coupon, the business management unit 2022 determines to re-distribute a coupon. In step S34, the business management unit 2022 generates and distributes the coupon data. The coupon generated in step S34 may have a content more advantageous for the users than that of the coupon generated in step S18. For example, the coupon may present a higher discount rate for a specific commodity or service. This is an effective policy when an actual business result does not satisfy a predicted value (or when it is predicted that the actual business result does not satisfy the predicted value at this rate).

### MODIFICATION

The aforementioned embodiments are merely examples, and the present disclosure can suitably be changed without departing from the scope of the present disclosure. For example, the processes or means described in the present disclosure can freely be combined and implemented without departing from the range of technical consistency.

In the description of the embodiments, the tour route of the mobile shop vehicle 100 is determined with priority given to the areas where there is a demand for a commodity or service. However, priority is not necessarily given to the areas having the demand. For example, the tour route may be determined with priority given to such elements as operational efficiency and operation costs, and then coupon distribution may be performed to approximate the business result to an ideal value.

Moreover, the process described to be performed by one apparatus may be executed by a plurality of apparatuses in cooperation with each other. Alternatively, the processes described to be executed by different apparatuses may be executed by one apparatus. In a computer system, the hardware configuration (server configuration) that implements each function may flexibly be changed.

The present disclosure can also be implemented when a computer program, mounted with the functions described in the embodiments, is supplied to a computer, and one or more processors included in the computer read and execute the program. Such a computer program may be provided to the computer by a non-transitory computer readable storage medium that is connectable with a system bus of the computer, or may be provided to the computer through a network. Examples of the non-transitory computer readable storage medium include disks of any type, including magnetic disks (such as floppy (registered trademark) disks, and hard disk drives (HDDs)) and optical discs (such as CD-ROMs, DVD discs, Blu-ray disc), and media of any type suitable for storing electronic commands, including read only memories (ROMs), random-access memories (RAMS), EPROMs, EEPROMs, magnetic cards, flash memories, and optical cards.

What is claimed is:

1. An information processing apparatus for controlling a mobile object configured to provide a commodity or service while touring a plurality of areas, the apparatus comprising a control unit configured to execute:
predicting a business result of the mobile object that tours the areas, and generating business prediction data; and
generating a coupon to be provided to users who are present in any one of the areas and distributing coupon data including the coupon to terminals associated with the users such that the business result satisfies a prescribed policy.

2. The information processing apparatus according to claim 1, wherein the control unit is configured to determine a discount rate of the coupon for each of the areas based on the prescribed policy.

3. The information processing apparatus according to claim 1, wherein the control unit is configured to:
acquire demand data that is information regarding a demand in the areas; and
generate a route for touring the areas based on the demand data.

4. The information processing apparatus according to claim 1, wherein the control unit is configured to:
re-predict the business result based on second demand data acquired after transmitting the coupon data; and
generate and distribute a second coupon higher in discount rate than the coupon such that the business result satisfies the prescribed policy.

5. The information processing apparatus according to claim 4, wherein the second demand data is data including a response situation from the terminals that are transmission destinations of the coupon.

6. The information processing apparatus according to claim 1, wherein the control unit is configured to:
acquire business achievement data from the mobile object on tour;
re-predict the business result in consideration of the business achievement data; and
generate and distribute a third coupon higher in discount rate than the coupon such that the business result satisfies the prescribed policy.

7. The information processing apparatus according to claim 1, wherein the control unit adds to the coupon data information regarding time when the mobile object reaches the corresponding area.

8. A method of information processing performed by an information processing apparatus for controlling a mobile object configured to provide a commodity or service while touring a plurality of areas, the method comprising the steps of:
predicting a business result of the mobile object that tours the areas and generating business prediction data; and
generating a coupon to be provided to users who are present in any one of the areas and distributing coupon data including the coupon to terminals associated with the users such that the business result satisfies a prescribed policy.
